(19) United States
(12) Patent Application Publication
(10) Pub. No.: US 2023/0182348 A1
(43) Pub. Date: Jun. 15, 2023

(54) TOOL ASSEMBLY FOR MANUFACTURING PARTS AND A METHOD OF PRODUCING A TOOL ASSEMBLY

(71) Applicant: Essentium IPCo, LLC, Pflugerville, TX (US)

(72) Inventors: Nirup Nagabandi, Pflugerville, TX (US); Luke Johnson, Austin, TX (US); Kevin Holder, Pflugerville, TX (US); Elisa Teipel, Pflugerville, TX (US); Thomas Colin Mulholland, Austin, TX (US)

(21) Appl. No.: 17/997,592

(22) PCT Filed: Apr. 30, 2021
(86) PCT No.: PCT/US21/30225

§ 371 Date: Oct. 31, 2022

Related U.S. Application Data
(60) Provisional application No. 63/018,879, filed on May 1, 2020.

(51) Int. Cl. B29C 33/38; B29C 33/04; B29C 35/02

(52) U.S. Cl. CPC B29C 33/3842; B29C 33/04; B29C 35/02; B33Y 80/00

(57) ABSTRACT

A tool assembly and a method for manufacturing and sealing a tool assembly for manufacturing an article includes building a tool assembly using additive manufacturing or 3D printing processes.

### CROSS-REFERENCE TO RELATED APPLICATIONS

The present application is a national stage of International Application No.: PCT/US21/30225, filed on Apr. 30, 2021, which claims the benefit of U.S. Provisional Application No. 63/018,879, filed on May 1, 2020, the teachings of which are incorporated herein.

### FIELD

The present disclosure relates to tooling for the manufacture of parts, and more specifically to a method of producing and sealing a tool assembly for manufacturing parts using a variety of processes.

### BACKGROUND

The statements in this section merely provide background information related to the present disclosure and may or may not constitute prior art.

Equipment part manufactures are constantly searching for new ways to improve product cycle time and shortening the product design process. When providing the best quality products for complicated assemblies having thousands of parts, multiple iterations of prototype or preproduction builds are required.

In producing production level parts such as metal stampings or injection molded plastic parts, production level tooling and molds are expensive and have very long build times. Thus, production level tooling and molds are not a viable option when producing prototype or preproduction level parts. Therefore, preproduction tooling is beneficial for producing a limited number of parts having nearly the same functionality. However, preproduction tooling still has long lead times that further prevent the acceleration of the preproduction process. Furthermore, although less expensive than production tooling, preproduction tooling is still expensive further applying pressure to the ability of reducing the cost of the equipment manufacturing process.

While current preproduction tooling and molds have a variety of uses and performance capabilities, they fail to further improve parts production efficiency, costs, and product utility. Thus, while the current tooling, molds and processes are useful for their intended purpose, there is room in the art for an improved tooling, molds, and manufacturing processes that provides improved investment cost, build time, design flexibility, and quality.

### SUMMARY

This disclosure describes a system and method for producing and sealing tool assemblies such as molds using additive manufacturing with high performance plastic filament. Tool assemblies of the present disclosure are created using CAD (computer-aided design), and when necessary, cooling channels are strategically designed according to the model of the piece and the print orientation. Molds are three-dimensional (3D) printed using extrusion based additive printing out of one or more thermoplastic materials. The 3D printed tool assembly may include post-processing such as computer numerical control (CNC) machining when necessary to achieve Geometric Dimensioning and Tolerance (GD&T) standards according to the application. If cooling channels are included in the tool assembly a viscous liquid sealant at high pressure is infused into the cooling channels and cured to ensure the cooling channels are gas and liquid tight at elevated pressures above atmospheric pressure. The system and method of the present disclosure can be used to seal tool assemblies that may be used in a variety of manufacturing applications including but not limited to: stamping, foaming, injection molding, compression molding, resin transfer molding (and vacuum assisted), thermoforming, vacuum forming, investment casting, spin casting, and blow molding.

The present system and method have a high turn-around rate, being produced in one to two (1-2) weeks with lower cost than traditional metal tooling. This system and method is also relevant to a variety of manufacturing industries by supporting most tooling/molding methods including stamping, foaming, injection molding, compression molding, resin transfer molding/vacuum assisted resin transfer molding, specifically for thermoset resins and filling preforms, thermoforming/vacuum forming, investment casting (as the preform sacrificial layer), spin casting, and blow molding.

The system and method of the present disclosure allows high design flexibility and by combining additive and subtractive manufacturing (when required), tools and molds will be produced faster and cheaper than using conventional metal mold fabrication processes. This results in affordable molds even when used for low part quantities, design iterations, prototyping and creation of new models for product evolution and innovation.

The system and method of the present disclosure is based on design for manufacturing (DFM) methods. This ensures total compatibility with additive manufacturing fabrication, as well as ease of assembly with the hardware that will form part of the mold for its incorporation into an injection molding machine or other mold forming machines.

The system and method of the present disclosure can be adjusted to match any commercial molding machine hardware.

The system and method of the present disclosure seals the tool assembly to be compatible with pressurized coolant systems and it is suitable to be used in industrial machines.

The system and method of the present disclosure uses high temperature thermoplastic materials employing additive manufacturing. This is beneficial because thermoplastic materials are less expensive and easier to work with than metals in the formation of tool assemblies and molds. The materials and use of additive manufacturing also allow for easy replication.

The system and method of the present disclosure is initiated using computer assisted design (CAD) software to create a model. The model can be designed with or without cooling channels depending on the tooling purpose. Once the model is complete, it is imported into a slicing software used to generate the extrusion based additive printing path with specific print settings according to the material, including print temperature, print speed, print extrusion, layer height and width. This is referred to as a G-code which is then transferred to a 3D printer capable of printing the volume of the part. Depending on the material used, the 3D printer must have a heated bed and a heated build volume.

Upon completion, the printed part is removed from the 3D printer. Post-processing steps may then be used to complete the tool assembly of the present disclosure. Sacrificial (support/base/brim/skirt/raft) material may be first removed by a computer numerical control (CNC) machine. If cooling channels are designed into the tool assembly, entry and exit ports of the cooling channels are cleaned and may be tapped to allow threading of coolant connectors and hosing.

Polymer extrusion 3D printing produces parts, tool assemblies or molds having many material layers which are generally not moisture resistant, as individual layers can absorb moisture, form voids between successive layers and therefore leak coolant. Coolant leakage may subsequently result in tool assembly failure from coolant loss and tool assembly overheating or if the coolant leaks into the tool assembly rendering the tool assembly dysfunctional. The system and method of the present disclosure therefore further infuses a sealant into the 3D printed part to create a tool assembly that can withstand pressurized coolant without leaking.

The process to infuse sealant into the tool assembly requires preheating the tool assembly followed by introduction of a flowable material at a controlled rate to minimize formation of bubbles, with the flowable material initially filling the cooling channels. Once the cooling channels are full, the cooling channels having the sealant fluid are pressurized inside the tool assembly to a pressure ranging between approximately 60 psi to approximately 100 psi and up to approximately 150 psi and held at pressure for a minimum of 60 seconds. After these infusion and pressurization steps, residual sealant fluid is removed from the cooling channels by positioning the tool assembly on a spin table and rotating the tool assembly to centrifugally remove residual sealant from the tool assembly cooling channels to ensure no cooling channels or coolant ports are clogged with residual fluid. The flowable sealant material remaining in the cooling channels is then set or cured using a curing process. It is noted if any one or all of the cooling channels for a tool assembly design are not needed, a small diameter hole may be tapped into a side or edge of the tool assembly and filled with the flowable sealant material for added support and functionality.

An additional option for sealing the tool assembly is electroplating and polishing. This can be accomplished using an electroplating compatible thermoplastic material or by using a multi-step process that will allow electroplating of an outer tool assembly surface. The electroplating is on the tool assembly surface. An additional buffing step may then be applied help achieve a class A finish. Electroplating if used provides both the class A surface needed for automotive and other industries as well as mechanical property enhancement.

Once the sealing process is complete, the tool assembly is ready for use. Materials that can be used for the infusion/sealing process include but are not limited to high flow, high temperature stability two-part epoxies, ceramics (flowable), and electroplating materials.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side elevational view of a tool assembly half for manufacturing an article using a plastic injection molding process according to the principles of the present disclosure;

FIG. 2 is an end elevational view of the tool assembly for manufacturing an article of FIG. 1;

FIG. 3 is a partial cross-sectional view of the tool assembly from section 3 of FIG. 2;

FIG. 4 is a cross-sectional view of a tool assembly from section 4 of FIG. 1;

FIG. 5 is an end elevational view similar to FIG. 2 of a tool assembly having an exemplary cooling channel with multiple flow bends;

FIG. 6 is side elevational perspective view of the tool assembly of FIG. 5 positioned on a rotary spin table;

FIG. 7 is a flowchart depicting a method of manufacturing a tool assembly according to the principles of the present disclosure;

FIG. 8 is a cross-sectional end elevational view of an exemplary cooling channel following deposition of a layer of sealant; and

FIG. 9 is a block diagram illustrating an example computing device according to the principles of the present disclosure.

### DETAILED DESCRIPTION

The following description is merely exemplary in nature and is not intended to limit the present disclosure, application, or uses.

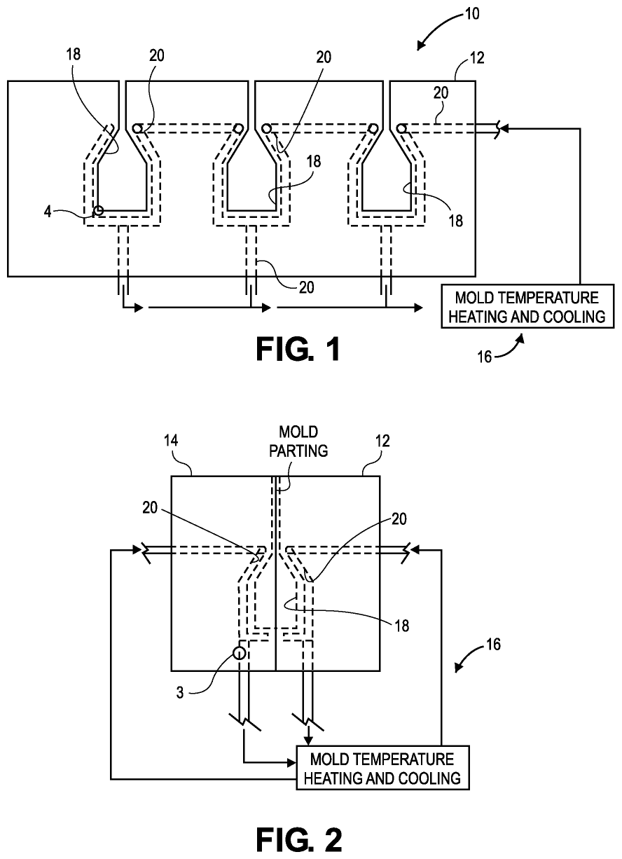

Referring now to FIGS. 1 and 2, a mold or a tool assembly 10 for use in a blow molding process is illustrated and will now be described. The tool assembly 10 or a similar mold or tool assembly may alternatively be used in another type of manufacturing process without departing from the scope of the present disclosure. The tool assembly 10 includes a first or upper half 12, a second or lower half 14, and a temperature control system 16. More particularly, the upper and lower halfs 12, 14 of the tool assembly include at least one part-cavity 18 and a plurality of cooling channels 20 in communication with the temperature control system 16. The cooling channels 20 are arranged to provide the most consistent operating temperatures possible in the tool assembly 10. For example, since the cooling channels 20 are printed by a 3D printer, the variety of shapes, sizes, and cross sections of the cooling channels 20 that can be built is much greater than cooling channels in traditionally machined tool assemblies. The flow rate of coolant through the cooling channels can be varied by altering the cross section of a particular cooling channel 20. Cooling channels 20 can even be printed to produce heat transfer effects that have not been possible in prior tool assembly building methods.

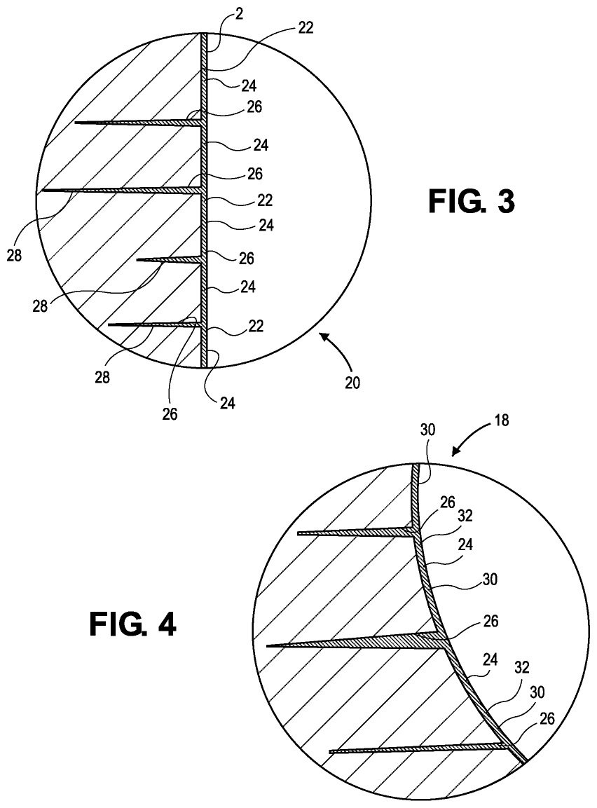

Referring now to FIG. 3, a cross section of the surface 22 of a cooling channel 20 from the tool assembly shown in FIG. 2 is illustrated and will now be described. Being that the tool assembly is built using a 3D printing or additive process, the tool assembly is predominantly created by layers 24 that are fused together that produce some voids or vacancies 26 between the layers 24 that may not have fused together completely. The surface 22 further includes a pressurized and cured sealant 28 that extends between the layers 24 and coats the surface 22 thus providing a passage that can withstand high pressure and temperatures without yielding. In the present example, the sealant is a two-part high temperature cured epoxy. However, other types of sealants may be incorporated into the tool assembly 10 without departing from the scope of the present disclosure.

Referring now to FIG. 4, a cross section of the surface 30 of a part cavity 18 from the tool assembly shown in FIG. 1 is illustrated and will now be described. Being that the tool assembly is built using a 3D printing or additive process, the tool assembly is predominantly created by layers 24 that are fused together that produce some voids or vacancies 26 between the layers 24 that may not have fused together completely. Furthermore, depending upon the thickness of the layers 24, some applications may require additional machining to achieve required shapes and tolerances. For example, the surface 30 is shown having been CNC machined to achieve the specified shape of the tool cavity 18. The surface 30 further includes a pressurized and cured sealant 28 that extends between the layers 24. Additionally, in some applications, once the surface 30 is sealed a layer of deposited metal 32 may be included to provide for improved wear resistance, impact strength, and surface finish.

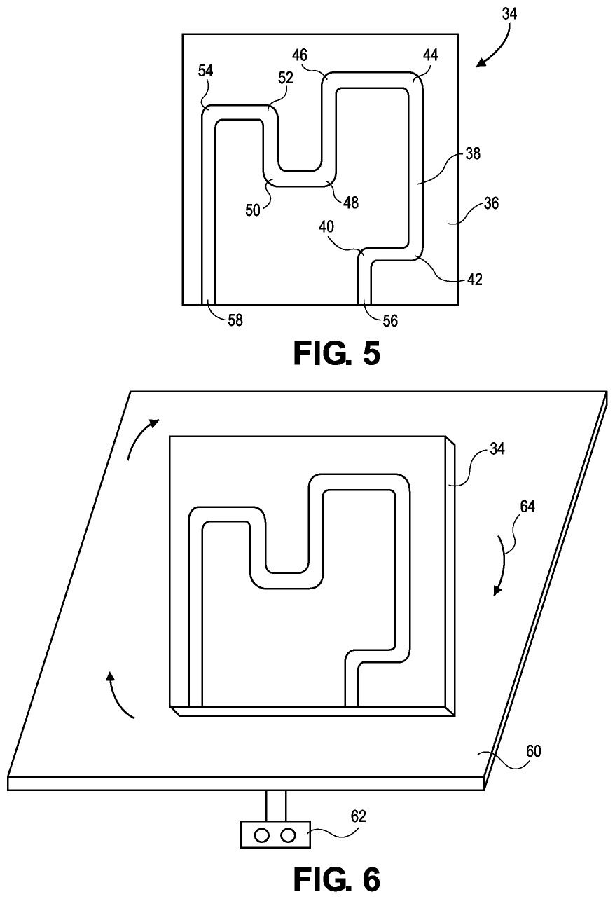

Referring to FIG. 5, according to several aspects, a tool assembly 34 of the present disclosure includes a mold or tool assembly body 36 having an exemplary cooling channel 38 similar to the cooling channel 20. The cooling channel 38 includes at least one and according to several aspects multiple flow bends 40, 42, 44, 46, 48, 50, 52, 54 between a flow inlet port 56 and an outlet port 58.

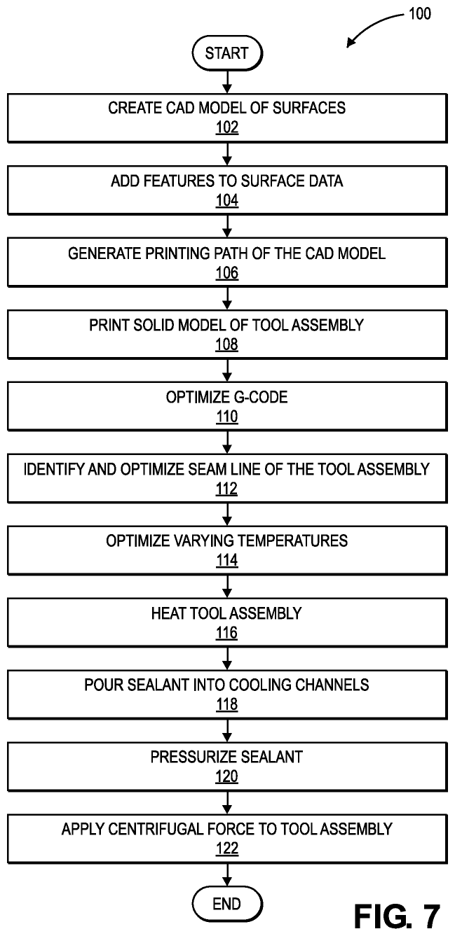

Referring to FIG. 6, after infusion of the sealant into the cooling channel 34 as described below in reference to FIG. 7, the tool assembly 34 is placed proximate to a center of a spin table 60. A motor 62 connected to the spin table 60 is energized to rotate the spin table 60, for example in a clockwise direction of rotation 64. Rotation of the spin table 60 generates centrifugal forces on the tool assembly 36 which act to push excess sealant out of the cooling channels 38. It is noted the spin table 60 provides an exemplary source of centrifugal force and may be replaced by any device or system that generates centrifugal forces on the tool assembly.

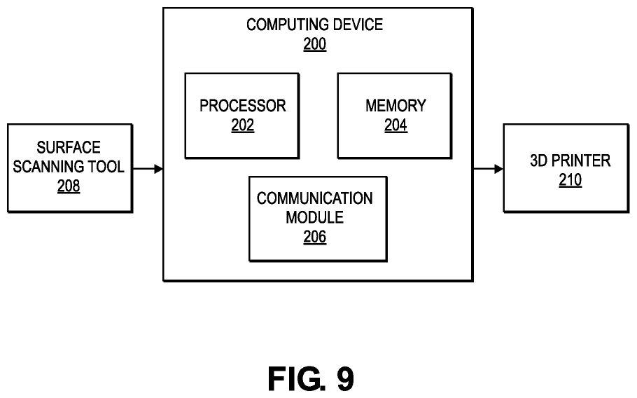

Referring to FIG. 7, a method 100 is depicted for creating the tool assemblies of the present disclosure such as the tool assembly 10 described in reference to FIG. 1 or the tool assembly 34 described in reference to FIG. 5 for use in the manufacture of parts using a variety of manufacturing processes. Portions of the method 100 may be carried out by a processor of one or more computing devices, such as a computing device described in connection with FIG. 9, for example. The method 100 described herein is for creating a tool assembly for use in a plastic injection mold process. However, many other types of tool assemblies for use in many other manufacturing processes may be built using the method 100 described herein. For example, tool assemblies or mold assemblies may be built for metal stamping, foaming, injection stretch blow molding, compression molding, metal casting sand core making, resin transfer molding, thermoforming, investment casting, spin casting, and blow molding without departing from the scope of the present disclosure.

The method 100 includes a first step 102 of making a CAD model of surfaces of a tool assembly such as the tool assembly 34. The CAD model may be created by using a surface scanning tool that uses a laser measuring device to convert the surface of a solid master part model into digital surface data. The CAD model may also be created partially from a CAD model of a desired part. Once the CAD model of the surface or surfaces of the tool assembly is created, a second step 104 adds features to the surface data including but not limited to tool design features such as parting surfaces, cooling channels, ejection pin holes, vent holes, and injection passages, thereby creating a CAD model of the tool assembly.

Next, a third step 106 uses a conversion or slicing software and generates a printing path of the CAD model of the tool assembly and transfers the printing path to a 3D printer. In a fourth step 108 a solid model of the tool assembly is printed using a 3D printer. In some applications, the 3D printing process includes using a high temperature, high performance thermoplastic filament that produces a high strength printed part capable of sustaining high stresses and high temperature manufacturing processes. Other 3D printing materials and processes intended to increase the strength and durability of the solid model of the tool assembly may also be used without departing from the scope of the present disclosure.

Following generation of a G-Code, in a fifth step 110 a G-Code is optimized using a programming script such as but not limited to, a python script, to optimize multiple items, for example a minimum or a least amount of travel moves is developed. In a sixth step 112 a single seam line of the tool assembly is identified and optimized. In a seventh step 114 a plurality of varying temperatures of the tool assembly are optimized based on infill of printed parts versus outlines of the printed parts. The above optimizations are performed to obtain a best finish of the 3D printed part made using the tool assembly and to obtain a highest strength of the 3D printed part.

In an eighth step 116 the tool assembly is heated in an oven at approximately 70 degrees C. for approximately 4 hours, which allows the tool assembly to rid thermally induced mechanical stresses and to prevent formation of further voids, gaps and pores. The tool assembly is then taken out of the oven.

In a ninth step 118 while the tool assembly is still at or near oven temperature a sealant is poured into any cooling channels such as the cooling channels 20, 38 with the elevated temperature of the tool assembly 34 allowing the sealant to begin curing as quickly as the sealant comes into contact with surfaces inside the tool cooling channels 38. Rapid curing also allows the sealant proximate to the tool cooling channel surfaces such as surfaces described in reference to FIGS. 3 and 4 to immediately increase in viscosity to improve coating of the sealant. According to several aspects, a preferred sealant is one of a high flow, high temperature two-part epoxy and a flowable ceramic however, other flowable, curable sealants may be used without departing from the scope of the present disclosure.

In a tenth step 120 the sealant is pressurized to force the sealant into gaps or crevices defining voids of the cooling channel walls. In particular, the cooling channels 38 are filled with the sealant which is pressurized to a pressure ranging between approximately 60 psi up to approximately 100 psi for a pressurization period of 30 seconds or more and preferably at least 60 seconds. According to several aspects, the pressure applied to the cooling channels 38 may be approximately 150 psi for approximately 60 seconds to force the sealant to flow into the gaps within the cooling channels 38 to fill the gaps and the cooling channels 38 more completely.

After the pressurization period is completed and the pressure on the sealant is released, in an eleventh step 122 a centrifugal force is applied to the tool assembly to remove excess sealant from the tool assembly. According to several aspects the tool is placed proximate to a center of the spin table 60 described in reference to FIG. 6 and the motor 62 is energized to rotate the spin table 60. The motor 62 when energized generates centrifugal forces on the tool assembly 34 which act to push excess sealant out of the cooling channels 38. According to several aspects the spin table 60 may be rotated at a rotational velocity between approximately 75 rpm up to approximately 125 rpm for a minimum of 3 minutes, however other rotational speeds and spin durations may be selected. Rotation of the spin table 60 forces portions of the sealant that does not coat the cooling channels 38 out of the cooling channels 38 and therefore out of the tool assembly 34. It is noted the tool assembly 34 may be positioned in one or multiple different positions and orientations on the spin table 60. This allows centrifugal forces to be applied on the tool assembly in multiple planes of rotation and orientations to displace the excess sealant. As noted herein, the spin table 60 provides an exemplary source of centrifugal force and may be replaced by any device such as but not limited to a shaft or a tool tumbler that generates centrifugal forces on the tool assembly in multiple planes of rotation and orientations.

The residual heat maintained in the tool assembly 34 during the spinning step following removal from the oven helps to retain the sealant captured in the gaps and on the cooling channel surfaces of the cooling channels 38 due to increased viscosity of the sealant at the elevated tool assembly temperature. The increased viscosity sealant is thereby allowed to better bind to the tool assembly 34.

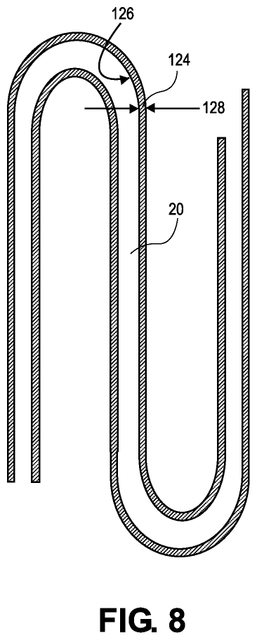

Referring to FIG. 8 and again to FIGS. 1 through 4, an exemplary layer 124 of remaining sealant is created along an inner wall 126 of the cooling channel 20 including sealant that has been infused into the voids of the cooling channel walls referred to in FIGS. 3 and 4 as the residual sealant is removed from the cooling channel 20. According to several aspects the layer 124 of remaining sealant may have a thickness 128 of approximately 3.0 mm, and may range in thickness from approximately 1.0 mm up to approximately 10.0 mm. According to further aspects, a second layer of the sealant may be applied if desired to build up the thickness 128 to a desired value. The thickness 128 may vary based on an initial temperature of the tool assembly and a spin rpm or centrifugal force applied using the source of centrifugal force. The remaining sealant may be cured in place as follows. The tool assembly is removed from the spin table 60 or the source of centrifugal force and left to cool completely to atmospheric temperature, for example over-night or for a period of approximately 8 or more hours. This cooling period permits the remaining sealant to cure completely.

FIG. 9 illustrates an example computing device 200. The computing device 200 can include a processor 202, a memory 204, and a communication module 206.

The processor 202 provides processing functionality for the computing device 200 and may include any number of processors, micro-controllers, or other processing systems, and resident or external memory for storing data and other information accessed or generated by the computing device 200. The processor 202 may execute one or more software programs which implement techniques described herein. The processor 202 is not limited by the materials from which it is formed or the processing mechanisms employed therein and, as such, may be implemented via semiconductor(s) and/or transistors (e.g., electronic integrated circuits (ICs)), and so forth.

The memory 204 is an example of tangible computer-readable media that provides storage functionality to store various data associated with the operation of the computing device 200, such as the software program and code segments mentioned above, or other data to instruct the processor 202 and other elements of the computing device 200 to perform the steps described herein. Although a single memory 204 is shown, a wide variety of types and combinations of memory may be employed. The memory 204 may be integral with the processor 202, stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth.

The communication module 206 provides functionality to enable the computing device 200 to communicate with one or more communication networks. In various implementations, the communication module 206 may be representative of a variety of communication components and functionality including, but not limited to: one or more antennas; a browser; a transmitter and/or receiver (e.g., radio frequency circuitry); a wireless radio; data ports; software interfaces and drivers; networking interfaces; data processing components; and so forth.

The computing device 200 can be communicatively connected to a surface scanning tool 208 and a 3D printer 210. In some example implementations, the computing device 200 can receive data representing a CAD model from another computing device via the one or more communication networks.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method comprising:
receiving a tool assembly including a plurality of layers defining at least one part-cavity and plurality of cooling channels;
pouring sealant into the plurality of cooling channels;
pressurizing the sealant to a pressure for a pressurization period; and
applying a centrifugal force to the tool assembly to remove excess sealant from the tool assembly, wherein the sealant extends between the plurality of layers.

2. The method as recited in claim 1, further comprising:
heating the tool assembly in an oven at approximately seventy degrees Celsius for approximately four hours.

3. The method as recited in claim 2, further comprising:
pouring the sealant into the tool assembly while the tool assembly is at or near seventy degrees Celsius.

4. The method as recited in claim 3, wherein the sealant is pressurized to a pressure ranging from approximately sixty pounds per square inch to approximately one hundred pounds per square inch.

5. The method as recited in claim 4, wherein the pressurization period comprises at least thirty seconds.

6. The method as recited in claim 4, wherein the pressurization period comprises at least sixty seconds.

7. The method as recited in claim 3, wherein the sealant is pressurized to at least one hundred and fifty pounds per square inch for a pressurization period of at least sixty seconds.

8. The method as recited in claim 7, wherein the tool assembly is rotated at a rotational velocity between approximately seventy-five revolutions per minute up to approximately one hundred and twenty-five revolutions per minute for at least three minutes.

9. The method as recited in claim 1, wherein the sealant comprises a two-part epoxy and flowable ceramic material.

10. A method comprising:
receiving a tool assembly including a plurality of layers defining at least one part-cavity and plurality of cooling channels;
pouring sealant into the plurality of cooling channels;
pressurizing the sealant to a pressure for a pressurization period; and
applying a centrifugal force to the tool assembly to remove excess sealant from the tool assembly at a rotational velocity between approximately seventy-five revolutions per minute up to approximately one hundred and twenty-five revolutions per minute for at least three minutes, wherein the sealant extends between the plurality of layers.

11. The method as recited in claim 10, further comprising:
heating the tool assembly in an oven at approximately seventy degrees Celsius for approximately four hours.

12. The method as recited in claim 11, further comprising:
pouring the sealant into the tool assembly while the tool assembly is at or near seventy degrees Celsius.

13. The method as recited in claim 12, wherein the sealant is pressurized to a pressure ranging from approximately sixty pounds per square inch to approximately one hundred pounds per square inch.

14. The method as recited in claim 13, wherein the pressurization period comprises at least thirty seconds.

15. The method as recited in claim 13, wherein the pressurization period comprises at least sixty seconds.

16. The method as recited in claim 12, wherein the sealant is pressurized to at least one hundred and fifty pounds per square inch for a pressurization period of at least sixty seconds.

17. The method as recited in claim 10, wherein the sealant comprises a two-part epoxy and flowable ceramic material.

18. A tool assembly, comprising:
an upper half defining at least one part cavity and a plurality of cooling channels; and
a lower half defining at least one part cavity and a plurality of cooling channels,
wherein each cooling channel of the plurality of cooling channels defines a surface that includes a pressurized and cured sealant extending between one or more layers and that coats the surface.

19. The tool assembly of claim 18, wherein the sealant comprises a two-part high temperature cured epoxy.

20. The tool assembly of claim 18, wherein the plurality of cooling channels are configured to connect to a temperature control system.
